(19) United States
(12) Patent Application Publication
(10) Pub. No.: US 2026/0297389 A1
(43) Pub. Date: Oct. 1, 2026

(54) HEAT-SEALING PAPER FOR PACKAGING A SOLID PRODUCT

(71) Applicant: RICCOBONO PATENTS LIMITED, DUBLIN (IE)

(72) Inventor: Camille HOARAU, AUBAIS (FR)

(21) Appl. No.: 19/153,828

(22) PCT Filed: Feb. 8, 2024
(86) PCT No.: PCT/EP2024/053221

§ 371 Date: Aug. 12, 2025

(30) Foreign Application Priority Data
Feb. 10, 2023 (FR) FR2301252

(51) Int. Cl. C09J 7/21; C09J 7/35; D21H 19/68; D21H 27/10

(52) U.S. Cl. CPC C09J 7/21; C09J 7/35; D21H 19/68; D21H 27/10; C09J 2301/204; C09J 2301/304; C09J 2400/283

(57) ABSTRACT

The invention relates to heat-sealing paper (1) for packaging a solid product, comprising at least one layer of cellulose fibres (2), and at least one layer of hot-melt adhesive (3). According to the invention, the at least one hot-melt adhesive layer (3) is deposited on the cellulose fibre layer (2) in a discontinuous manner over the entire length and width of the cellulose fibre layer, the hot-melt adhesive layer having a melting point at a temperature above 80°C.

### TECHNICAL FIELD

The invention relates to the technical field of heat-sealing papers suitable for use in packaging, more particularly the packaging of a solid product, such as press copies, bottles, or even dry food.

The invention also relates to a method for manufacturing a heat-sealing paper and to a device for implementing said method.

### PRIOR ART

It is necessary to package solid products, such as press copies, in packaging in order to protect them during transport. Typically, the packaging for these solid products, such as press copies, is in the form of a film made primarily of plastic.

However, in recent years, legislation in many countries has reduced the use of plastic in all types of industry. Therefore, manufacturers of plastic films for packaging products, particularly solid ones, must find an alternative material for packaging in order to preserve its properties, such as low cost and good protection.

To this end, manufacturers of packaging films for products, particularly solid ones, have replaced plastic with packaging made from paper fibers that are glued in a specific location at which the welding for sealing the packaging is carried out.

However, such a method requires a high level of adaptability on the part of the machines as a function of the differences in the dimensions of the solid products to be packaged, such as press copies, but also dry food or packaging. To wit, sealing the packaging by gluing then requires modifying the packaging devices in accordance with the different dimensions of the solid products.

In order to adapt to the different dimensions, these devices must undergo heavy modifications, resulting in a elaborate and costly packaging process.

Alternatively, manufacturers have produced a heat-sealing paper packaging comprising a layer of plastic—generally polyethylene terephthalate known by the acronym “PET”—that makes a welding of the plastic possible. There is therefore no longer any problem with regard to the adaptability of the machines, which reduces the cost of the process. Nevertheless, the use of plastic, even in small quantities, leads to ecological problems.

Another method involves a water-based heat-sealing paper made by coating the paper with a cold water-based adhesive.

This method requires depositing a layer of water-based adhesive and then removing all the water present in the water-based adhesive, said adhesive being composed of approximately 60% water, in order to leave only pure adhesive or adhesive extract.

Thus, in order to leave only the minimum quantity necessary for this process, it is impossible to make this deposit in one pass because the quantity of water deposited would be too great and would have the effect of damaging or even breaking the strip of paper.

Therefore, manufacturers carry out multiple successive coatings of water-based adhesive in a smaller quantity. Each of the adhesive coating steps is followed by a heat-drying step to reduce the aqueous phase of the adhesive during coating. Therefore, such a process is energy-intensive and expensive, which also makes it very expensive to use the resulting paper, resulting in infrequent use of the paper.

It is in this context where the invention comes in and seeks to resolve all of the aforementioned drawbacks.

It is therefore an aim of the invention to manufacture a heat-sealing paper that is less expensive, is ecological, and adaptable to different devices for packaging solid products, in particular press copies.

### PRESENTATION OF THE INVENTION

The invention relates to a heat-sealing paper that is less expensive, is ecological, and adaptable to various machines for packaging solid products, particularly press copies.

It is another object of the invention to provide a method for manufacturing heat-sealing paper according to the invention quickly and less expensively, said paper being suitable for packaging, in particular of press copies.

It is another object of the invention to provide a device for implementing said method of manufacturing heat-sealing paper according to the invention.

For this purpose, a heat-sealing paper has been developed for packaging a solid product which comprises at least one cellulose fiber layer and at least one hot-melt adhesive layer.

According to the invention, the at least one hot-melt adhesive layer is deposited on the cellulose fiber layer in a discontinuous manner over the entire length and width of the cellulose fiber layer, the hot-melt adhesive layer having a melting point above a temperature of 80°C.

It is therefore understood that the hot-melt adhesive layer does not contain water and is deposited hot, avoiding the long and expensive process of cold-depositing the adhesive.

A heat-sealing paper is thus obtained which does not have a layer of plastic material, allowing it to be manufactured in an ecological and less expensive manner, so that when the paper is exposed to a temperature above 80°C, the hot-melt adhesive layer melts and forms a bond with the cellulose fibers to create a rigid and strong structure.

In addition, the presence of a hot-melt adhesive layer makes it possible to eliminate the successive coating and drying steps required when using a cold water-based adhesive which make the process cumbersome and expensive.

After all, using a water-free adhesive that is applied hot means that it isn't to apply multiple layers of water-based adhesive.

What is more, the fact of a layer of heat-activated hot-melt adhesive makes the heat-sealing paper adaptable to any device for packaging solid products, in particular press copies. In fact, all that is required in order to cause the heat-sealing paper to stick to itself for the purpose of carrying out the packaging is to heat the heat-sealing paper sufficiently to reactivate the hot-melt adhesive.

The deposition of the hot-melt adhesive layer on the cellulose fiber layer in a discontinuous manner makes it possible to create a heat-sealing paper comprising a hot-melt adhesive layer which is not distributed homogeneously on the cellulose fiber layer.

The term “discontinuous” means that the hot-melt adhesive layer is distributed non-uniformly over the entire width and length of the cellulose fiber layer.

In fact, following the deposition of the hot-melt adhesive layer on the cellulose fiber layer, said hot-melt adhesive layer is grouped together into small clusters arranged in an uncontrolled manner over the entire length and width of the cellulose fiber layer.

It is therefore understood that the term “discontinuous” relates to the random manner in which the small clusters of adhesive are distributed over the cellulose fiber layer and not to a discontinuous distribution on account of it not being continuous.

In a particular embodiment, the hot-melt adhesive layer comprises a mixture of hot-melt resin in contact with the cellulose fiber layer, such that, when the paper is exposed to a temperature above 80°C, the hot-melt resin adhesive layer melts and forms a bond with the cellulose fibers and the layer of thermoplastic polymer.

Preferably, the hot-melt adhesive layer is deposited on the cellulose fiber layer in a density of 1 to 8 g/m².

In a more preferred embodiment, the hot-melt adhesive layer is deposited on the cellulose fiber layer in a density of 2 to 5 g/m².

More preferably, the hot-melt adhesive layer is deposited on the cellulose fiber layer in a single pass.

The term “density” is intended to specify the fact that there are between 1 and 8 grams of hot-melt adhesive on a surface of one square meter of cellulose fiber.

Thus, the use of a small quantity of hot-melt adhesive makes it possible to reduce the manufacturing cost of such paper while producing a heat-sealing paper whose adhesive strength is sufficient for packaging solid products, in particular press copies.

In a particular embodiment, the cellulose fiber layer and the hot-melt adhesive layer are arranged such that the deposition of the hot-melt adhesive layer on the cellulose fiber layer forms multiple deposits of said hot-melt adhesive on the cellulose fiber layer, said deposits being interconnected to one another on the cellulose fiber layer.

Thus, the surface tension of the hot-melt adhesive and that of the cellulose fiber layer form multiple deposits of said hot-melt adhesive on the cellulose fiber layer, said deposits remaining connected to one another on the cellulose fiber layer.

Due to its surface tension, the hot-melt adhesive layer thus groups together into points of clusters linked to the cellulose fibers.

Indeed, the quantity of hot-melt adhesive is such that the surface tension of the hot-melt adhesive creates a hot-melt adhesive layer having deposit irregularities, forming areas having a lower quantity of adhesive than in other areas which have a greater quantity, said areas which have a greater quantity of adhesive forming said deposits. This uneven distribution of hot-melt adhesive is due to the small amount of hot-melt adhesive applied to the cellulose fiber layer.

The hot-melt adhesive therefore has difficulty spreading, resulting in the formation of hot-melt adhesive clusters on the cellulose fiber layer.

Such a hot-melt adhesive layer thus makes it possible to achieve sufficient bonding for the packaging of solid products, in particular of press copies. However, the uneven distribution of hot-melt adhesive deposits does not enable a watertight bond to be formed and is therefore not suitable for use in the field of liquid products, for example.

In a preferred embodiment, the deposits of hot-melt adhesive are distributed inhomogeneously over the cellulose fiber layer.

The random distribution of hot-melt adhesive deposits is due to the particular spreading of the hot-melt adhesive. Since the adhesive is spread over a large surface, the hot-melt adhesive groups into small clusters in random areas on the cellulose fiber layer.

More particularly, the surface tension of the adhesive does not allow for the formation of a uniform layer of adhesive and creates a non-uniform coating which forms a network of random groups of adhesive.

In a particular embodiment, the cellulose fiber layer comprises a mixture of long and short cellulose fibers.

In a particular embodiment, the proportion of long cellulose fibers is greater than the proportion of short cellulose fibers.

In one embodiment, the cellulose fiber layer comprises a thickness of between 20 and 50 micrometers.

The invention also relates to a method for manufacturing a heat-sealing paper according to the invention and comprises at least the steps of continuously supplying paper comprising at least one cellulose fiber layer, continuous hot application of the hot-melt adhesive to at least one side of the cellulose fiber layer, cooling the hot-melt adhesive on the cellulose fiber layer, and continuously rolling up the heat-sealing paper.

The hot-melt adhesive is applied hot over the entire length and width of the cellulose fiber layer, which allows for a simple and effective application step.

The step of applying the hot-melt adhesive is carried out continuously and in a single pass of the paper, meaning that the side of the paper to which adhesive is to be applied receives all of the hot-melt adhesive in a single application.

In a particular embodiment, the application step is carried out by means of a lip nozzle.

Preferably, in the step of applying the hot-melt adhesive layers, an amount of hot-melt adhesive is applied so as to form discontinuous deposits of said hot-melt adhesive on the cellulose fiber layer.

The application step is such that inhomogeneous deposits of said hot-melt adhesive are formed on the cellulose fiber layer.

In a preferred embodiment, the step of applying the hot-melt adhesive is carried out so as to apply between 1 and 8 grams of hot-melt adhesive to the surface of the cellulose fiber layer per square meter.

Thus, a low grammage of adhesive per square meter of cellulose fiber layer makes it possible not only to achieve savings in raw materials but also to carry out the application step in a single pass, thereby reducing production time and thus increasing productivity, all while providing sufficient adhesive for the packaging of solid products, in particular of press copies.

Furthermore, the fact that the hot application step is carried out on the entire side of the paper allows for great adaptability of the method depending on the packaging machines and thus significant savings due to elimination of the need to modify the packaging machines for solid products, in particular press copies. In point of fact, paper packaging films are usually glued and welded at specific points. However, these specific points change depending on the dimensions of the solid objects to be packaged, such as press copies, making the processes specific to each packaging machine.

Preferably, the application of the hot-melt adhesive to at least one side of the cellulose layer is carried out in a single pass.

Thus, the method for manufacturing heat-sealing paper is accelerated because it no longer requires the successive application of multiple layers of adhesive, each separated by a drying step in order to reduce the proportion of water in the adhesive so as not to weigh down the cellulose fiber layer, which can cause said cellulose fibers to break.

The invention also relates to a device for implementing the method for manufacturing heat-sealing paper according to the invention, said manufacturing device comprising at least one system for continuously supplying paper, at least one system for continuously applying the hot-melt adhesive to at least one side of the paper, and at least one system for continuously rolling up the heat-sealing paper previously obtained.

In a particular embodiment, the continuous application system for the hot-melt adhesive comprises a lip nozzle in order to apply 1 to 8 grams of hot-melt adhesive to one square meter of one side of the cellulose fiber layer.

The side of the heat-sealing paper is thus licked by the lip nozzles, depositing a small but quantity of hot-melt adhesive that is sufficient as to enable the packaging envelope to be sealed shut upon reactivation of the adhesive by a step of hot-welding the heat-sealing paper to itself during a packaging process using the heat-sealing paper according to the invention.

In another embodiment, the method comprises steps of packaging a solid product, in particular a press copy, comprising steps of folding the heat-sealing paper onto itself so as to package a solid product and a step of hot-cutting the previously folded heat-sealing paper.

Thus, the hot pressing of the heat-sealing paper reactivates the hot-melt adhesive layer of the heat-sealing paper, which enables the layers of cellulose fibers folded back on themselves to create bonds between the two layers of cellulose fibers via the hot-melt adhesive in order to package a solid product with the heat-sealing paper.

### BRIEF DESCRIPTION OF THE FIGURES

Other advantages and features of the present invention will now be described with the aid of examples, which are provided solely for purpose of illustration and are in no way limitative for the scope of the invention, and on the basis of the appended drawings, in which:

FIG. 1 is a schematic representation of a heat-sealing paper according to the invention.

FIG. 2 is a schematic perspective representation of the heat-sealing paper.

FIG. 3 is a schematic representation of a heat-sealing paper according to the invention.

In the following description, elements that are structurally or functionally identical that appear in different figures are denoted by the same references unless specified otherwise.

### DESCRIPTION OF EMBODIMENTS

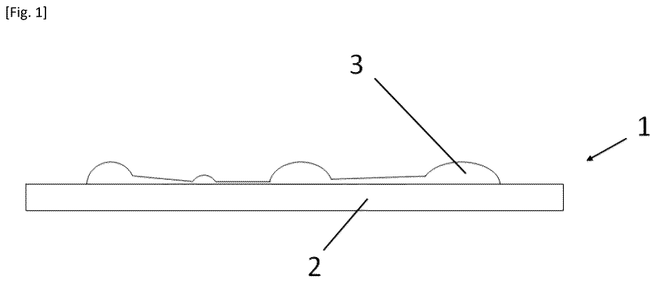

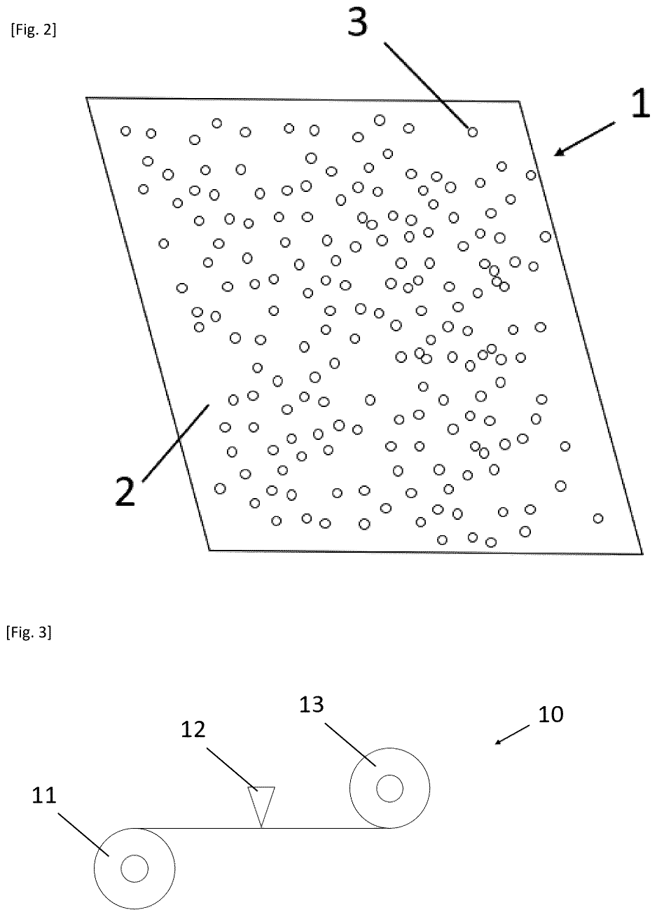

With reference to FIGS. 1 to 3, the present invention relates to a heat-sealing paper 1 for packaging a solid product, in particular press copies.

The heat-sealing paper 1 comprises a cellulose fiber layer 2 and a hot-melt adhesive layer 3, said hot-melt adhesive layer 3 being in contact with the cellulose fiber layer 2, so that, when the paper 1 is exposed to a temperature of 180°C, the hot-melt adhesive layer 3 melts and forms a bond with the cellulose fibers 2.

The hot-melt adhesive layer 3 is deposited on the cellulose fiber layer 2 discontinuously over the entire length and width of the cellulose fiber layer 2, the hot-melt adhesive layer having a melting point above a temperature of 100°C.

The heat-sealing paper 1 comprises a hot-melt adhesive layer 3 deposited on the cellulose fiber layer 2 in a density of three g/m².

Thus, three grams of hot-melt adhesive 3 are applied to a surface area of one square meter of the cellulose fiber layer 2.

The heat-sealing paper 1 thus has non-uniform hot-melt adhesive dots 3 which form a random network of hot-melt adhesive dots 3.

The cellulose fiber layer 2 and the hot-melt adhesive layer 3 are arranged such that the deposition of the hot-melt adhesive layer 3 on the cellulose fiber layer 2 forms multiple deposits of said hot-melt adhesive 3 on the cellulose fiber layer 2, said deposits being separated from each other on the cellulose fiber layer 2.

The surface tension of the hot-melt adhesive 3 forms multiple deposits of the hot-melt adhesive 3 on the cellulose fiber layer 2, said deposits being separated from each other on the cellulose fiber layer 2. The deposits of hot-melt adhesive 3 are distributed inhomogeneously over the cellulose fiber layer 2.

The heat-sealing paper 1 comprises a mixture of long and short cellulose fibers 2; more particularly, the proportion of long cellulose fibers 2 represents 75% of the total cellulose fibers 2.

The cellulose fiber layer 2 has a thickness of 37 micrometers.

The method 10 for manufacturing the heat-sealing paper 1 successively implements a step of continuously supplying paper comprising a cellulose fiber layer 2, of continuous hot application of the hot-melt adhesive 3 to one side of the cellulose fiber layer 2, of cooling the hot-melt adhesive 3 on the cellulose fiber layer 2, and of continuously rolling up the heat-sealing paper 1.

The method for packaging solid products, in particular press copies, comprises steps of welding and cutting the heat-sealing paper 1 by means of a welding system comprising a blade and at least one device for hot-pressing the heat-sealing paper 1. This reactivates the cooled hot-melt adhesive 3, which enables two parts of the heat-sealing film to be appropriately bonded together in order to obtain packaging for solid products which is particularly satisfactory for a press copy.

In order to cut and weld the heat-sealing paper 1, the heat-sealing paper 1 is hot-pressed on either side of a blade in order to stretch the heat-sealing paper 1 at a precise point at which cutting is to be performed. The hot pressure reactivates the hot-melt adhesive and enables two parts of the heat seal paper to be welded together.

The application step is carried out by means of a lip nozzle in a single pass of the cellulose fiber layer 2 over the lip nozzle.

The method 10 applies between three grams of hot-melt adhesive 3 per square meter to one side of the cellulose fiber layer 2 over the entire width and length of the cellulose fiber layer 2.

The application step and the surface tension of the hot-melt adhesive 3 form discontinuous deposits of said hot-melt adhesive 3 on the cellulose fiber layer 2.

The application step is such as to form random deposits of said hot-melt adhesive 3 on the cellulose fiber layer 2.

The invention also relates to a device for implementing the method 10 for manufacturing heat-sealing paper 1 constituting the object of the invention.

The manufacturing device comprises a system 11 for continuously supplying paper, a system 12 for continuously applying the hot-melt adhesive 3 to one side of the paper, and a system 13 for continuously rolling up the previously obtained heat-sealing paper 1.

The gluing system comprises a lip nozzle for applying three grams of hot-melt adhesive 3 to one side of the cellulose fiber layer 2.

The preceding description clearly explains how the invention makes it possible to achieve the objectives it has set itself, namely to reduce the manufacturing cost of packaging for solid products while being ecological and allowing for a high level of adaptability of the method to different devices for packaging solid products.

In any event, the invention cannot be limited to the embodiments specifically described in this document and extends in particular to any and all equivalent means and to any technically effective combination of these means.

1. A heat-sealing paper (1) for packaging a solid product, comprising:
at least one cellulose fiber layer (2) and
at least one hot-melt adhesive layer (3),
characterized in that the at least one hot-melt adhesive layer (3) is deposited on the cellulose fiber layer (2) discontinuously over the entire length and width of the cellulose fiber layer, the hot-melt adhesive layer having a melting point above a temperature of 80 °C.

2. The paper (1) according to claim 1, characterized in that the hot-melt adhesive layer (3) is deposited on the cellulose fiber layer (2) in a density of 1 to 8 g/m².

3. The paper (1) according to claim 2, characterized in that the cellulose fiber layer (2) and the hot-melt adhesive layer (3) are arranged such that the deposition of the hot-melt adhesive layer (3) on the cellulose fiber layer (2) forms multiple deposits of said hot-melt adhesive (3) on the cellulose fiber layer (2), said deposits being interconnected to one another on the cellulose fiber layer (2).

4. The paper (1) according to claim 3, characterized in that the deposits of the hot-melt adhesive (3) are distributed inhomogeneously on the cellulose fiber layer (2).

5. The paper (1) according to claim 1, characterized in that the cellulose fiber layer (2) comprises a mixture of long and short cellulose fibers (2).

6. A method (10) for manufacturing a heat-sealing paper (1) according to claim 1, characterized in that it comprises at least the following steps:
continuously supplying a paper comprising at least one cellulose fiber layer (2);
continuous hot application of a hot-melt adhesive (3) to at least one side of the cellulose fiber layer (2);
cooling of the hot-melt adhesive (3) on the cellulose fiber layer (2); and
continuous rolling-up of the heat-sealing paper (1).

7. The method (10) according to claim 6, characterized in that, in the step of applying the hot-melt adhesive (3), a quantity of hot-melt adhesive (3) is applied so as to form discontinuous deposits of said hot-melt adhesive (3) on the cellulose fiber layer (2).

8. The method (10) according to claim 6, characterized in that the step of applying the hot-melt adhesive (3) is carried out such that between 1 to 8 grams of hot-melt adhesive (3) are applied to the surface of the cellulose fiber layer (2) per square meter.

9. The method (10) according to claim 8, characterized in that the application of the hot-melt adhesive (3) to at least one side of the cellulose fiber layer (2) is carried out in a single pass.

10. A device for manufacturing a heat-sealing paper by implementing the manufacturing method (10) according to claim 6, characterized in that the device comprises:
at least one continuous paper supply system (11);
at least one system (12) for continuously applying a hot-melt adhesive (3) to at least one side of the paper; and
at least one system (13) for continuously rolling up the heat-sealing paper (1) previously obtained.
